(19) United States
(12) Patent Application Publication
(10) Pub. No.: US 2014/0310691 A1
(43) Pub. Date: Oct. 16, 2014

(54) METHOD AND DEVICE FOR TESTING MULTIPLE VERSIONS

(71) Applicant: Alibaba Group Holding Limited, George Town (KY)

(72) Inventor: Zhou Ou, Hangzhou (CN)

(21) Appl. No.: 14/249,256

(22) Filed: Apr. 9, 2014

(30) Foreign Application Priority Data
Apr. 12, 2013 (CN) 201310127577.4

(51) Int. Cl. G06F 11/36

(52) U.S. Cl. CPC G06F 11/368
USPC 717/124

(57) ABSTRACT

Embodiments of the present application relate to a method for testing multiple versions, a device for testing multiple versions, and a computer program product for testing multiple versions. A method for testing multiple versions is provided. The method includes acquiring diversion tag values of users visiting a current product, the diversion tag values uniquely identifying the corresponding users, calculating diversion hashed values of the diversion tag values, and allocating an old version and a new version of the current product to the users according to a preset old version or new version allocation ratio for the current product and the diversion hashed values to test multiple versions of the current product.

### CROSS REFERENCE TO OTHER APPLICATIONS

This application claims priority to People's Republic of China Patent Application No. 201310127577.4 entitled A MULTI-VERSION TESTING METHOD AND DEVICE, filed Apr. 12, 2013 which is incorporated herein by reference for all purposes.

### FIELD OF THE INVENTION

The present application relates to a method and device for testing multiple versions.

### BACKGROUND OF THE INVENTION

Products are continually being developed on the Internet. For example, on Taobao.com, after an old version of a product has been optimized, the optimized version of the product is the new version relative to old versions of the product. In website design, website versions are updated or optimized even more frequently in order to provide a better user experience. For example, a button on a website is red or blue, a module zone on a website is laid out horizontally or vertically, and a choice between different algorithms for several different weights or selection of some critically-positioned documents, etc. exist. One method for testing a difference in results of a new version and an old version of a website involves diverting flows between the new and old versions, storing records, and analyzing the results.

Testing multiple versions or multi-version testing is typically called A/B testing. Typically, A refers to an old version of the website, while B refers to a new version of the website. Multi-version testing is a new kind of production optimization method. In other words, users are divided into two groups: old version browsing and new version browsing. The old version users are given the old version of the website to view, and the new version users are given the new version of the website to view. In addition, the actions of the old version and new version users are recorded. Finally, in order to determine which version of the website is better, the old version and new version of the website undergo comparison testing based on data analysis of user actions vis-a-vis the old version and the new version.

A typical A/B testing process includes three parts: diversion, recording, and data analysis. Multiple forms of diversion exist. In one example, diversion occurs according to user ratio: During A/B testing, diversion is carried out according to a user dimension. If a total number of users visiting a website during an A/B testing period is 200,000, and a diversion ratio is 50% and 50%, then 100,000 users are allocated to the new version, and the other 100,000 users are allocated to the old version. In another example, diversion occurs according to a user request ratio: When A/B testing occurs, diversion is implemented according to a user request dimension. If a number of users visiting a website during the A/B testing period is 200,000, one user may visit the website several times. Assuming that each user visits seven times, and the diversion ratio is 50% and 50%, then 700,000 requests will be allocated to the new version, and the other 700,000 requests will be allocated to the old version. Clearly, a major difference between “diversion according to user ratio” and “diversion according to user request ratio” is, in the “diversion according to user ratio,” any one user always uses the same version. Moreover, the user quantity ratio corresponds with the diversion ratio, but the user request quantity ratio differs from the diversion ratio. Also, in the “diversion according to user request ratio,” one user can see different versions of the website. In addition, the user request quantity ratio and the diversion ratio can be the same or different. Of course, other diversion forms of A/B testing exist. Typically, the “diversion according to user ratio” is used because unlike the “diversion according to request ratio,” the “diversion according to user ratio” enables a single user to continually visit the same version, which provides a better user experience.

However, in the course of research, the behavior of each user varies and different behavior between users may lower the credibility and validity of the results of conventional testing of multiple versions. If a data verification method is subsequently used to verify the test results, for example, statistics-based verification is employed, making the process of verification extraordinarily complex.

### BRIEF DESCRIPTION OF THE DRAWINGS

Various embodiments of the invention are disclosed in the following detailed description and the accompanying drawings.

In order to describe more clearly the technical schemes in the embodiments of the present application, the drawings needed to describe embodiments are explained briefly below. Obviously, the drawings described below are only some embodiments of the present application. A person with ordinary skill in the art could, without expending inventive effort, acquire other drawings on the basis of these drawings.

FIG. 1 is a flowchart of an embodiment of a process for testing multiple versions.

FIG. 2 is a flowchart of an embodiment of a process for acquiring a diversion tag value of a user.

FIG. 3 is a flowchart of an embodiment of a process for generating a diversion tag value for a user.

FIG. 4 is a flowchart of another embodiment of a process for testing multiple versions based on conversion rates.

FIG. 5 is a flowchart of an embodiment of a process for testing an old version and a new version of a current product.

FIG. 6 is a flowchart of yet another embodiment of a process for testing multiple versions.

FIG. 7 is a structural diagram of an embodiment of a device for testing multiple versions.

FIG. 8 is a structural diagram of an embodiment of an acquiring module.

FIG. 9 is a structural diagram of an embodiment of a generating module.

FIG. 10 is a structural diagram of an embodiment of a device for testing multiple versions including a testing module.

FIG. 11 is a structural diagram of an embodiment of a testing module.

FIG. 12A is a structural diagram of yet another embodiment of a device for testing multiple versions.

FIG. 12B is a structural diagram of an embodiment of an optimizing module.

FIG. 13 is a diagram of an embodiment of a system for testing multiple versions.

FIG. 14 is a functional diagram of an embodiment of a computer system for testing multiple versions.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A method and device for testing multiple versions include the following: After acquiring a diversion tag value of a user visiting a current product, calculating a diversion hashed value of the diversion tag value, allocating an old version and a new version of the current product to the user according to a preset old version and a new version allocation ratio for the current product and the diversion hashed value to perform testing of multiple versions of the old version and the new version of the current product. In some embodiments, the product includes web page information transmitted by a website server via a network to a user client. In some embodiments, the diversion hashed values are obtained by hashing the diversion tag value of each user. A method for testing multiple versions based on the diversion hashed values is provided.

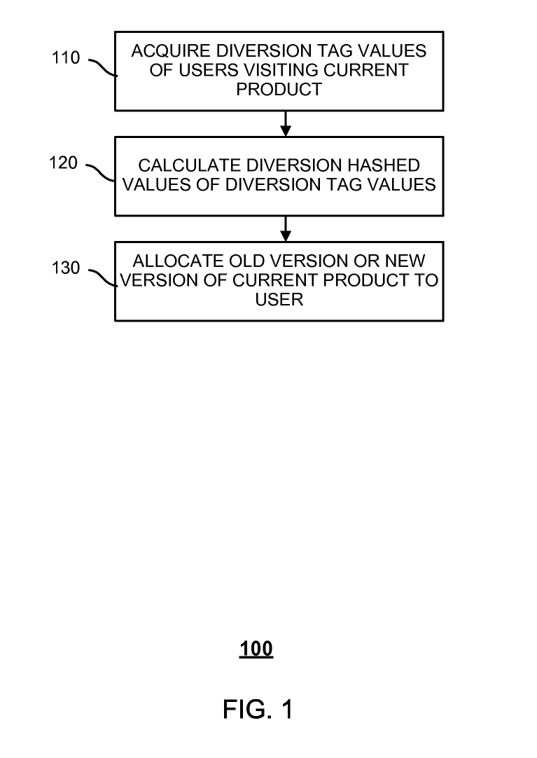

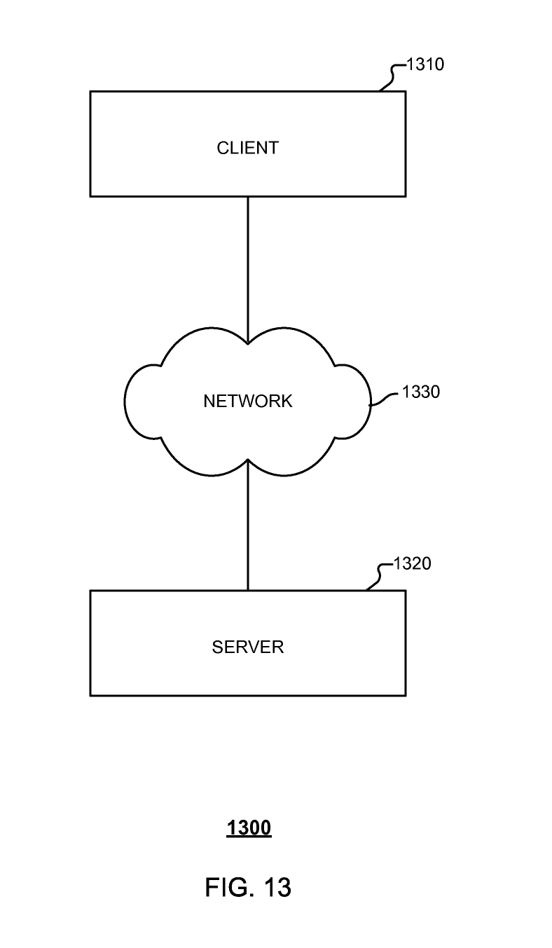

FIG. 1 is a flowchart of an embodiment of a process for testing multiple versions. In some embodiments, the process 100 is implemented by a server 1320 of FIG. 13 and comprises:

In 110, the server acquires diversion tag values of users visiting a current product. The diversion tag values correspond to unique identifications of the users.

First, the server acquires the diversion tag values of all users visiting the current product. In some embodiments, a diversion tag value is used to uniquely identify the current user visiting the current product. For example, User A triggers a request to visit the current product. In this case, after receiving the access request of User A, the server does not allocate to User A an old version or a new version of the current product that is to be visited, but instead, the server creates a diversion tag value based on an IP (Internet Protocol) address of the user, a first visit time of the user, and a random number. Accordingly, the diversion tag value is capable of uniquely identifying the user.

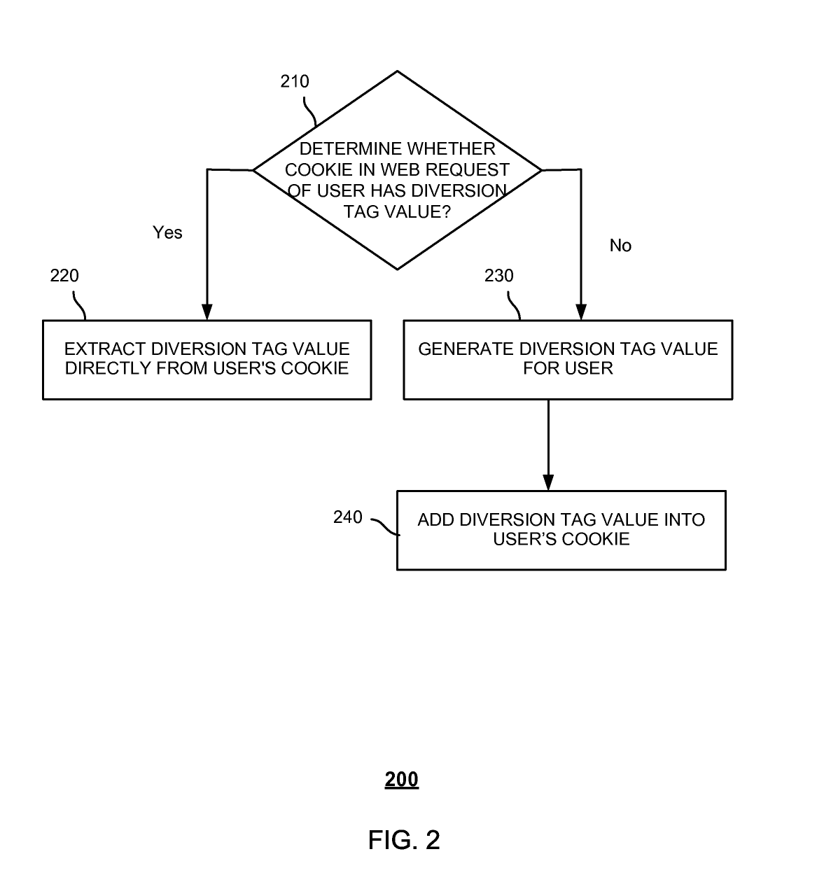

FIG. 2 is a flowchart of an embodiment of a process for acquiring a diversion tag value of a user. In some embodiments, the process 200 is an implementation of operation 110 of FIG. 1 and comprises:

In 210, the server determines whether a data cookie in a web request of a user has a diversion tag value. In the event that the data (cookie) in the web request of the user has the diversion tag value, control is passed to 220. In the event that the data (cookie) in the web request of the user does not have the diversion tag value, control is passed to 230.

In some embodiments, in the event that the server receives a web request from a user, first the server reads access data (cookie) in the web request to determine whether a diversion tag value exists. In the event that the diversion tag value already exists, the existence of the diversion tag value indicates that the user is not visiting the current product for the first time. In this case, the server directly extracts the diversion tag value from the cookie. In the event that the diversion tag value does not exist, the non-existence of the diversion tag value indicates that the user is visiting the current product for the first time. In this case, the server generates a diversion tag value for the user based on a preset technique used to generate diversion tag values.

In 220, in the event that the user's cookie in the web request has the diversion tag value, the server extracts the diversion tag value directly from the user's cookie.

In 230, in the event that the user's cookie in the web request does not have the diversion tag value, the server generates a diversion tag value for the user based on a preset technique used to generate diversion tag values.

In some embodiments, in the event that the user's cookie does not already have the diversion tag value, the server generates a character string that uniquely labels the user, i.e., a diversion tag value, based on a preset technique used to generate diversion tag values.

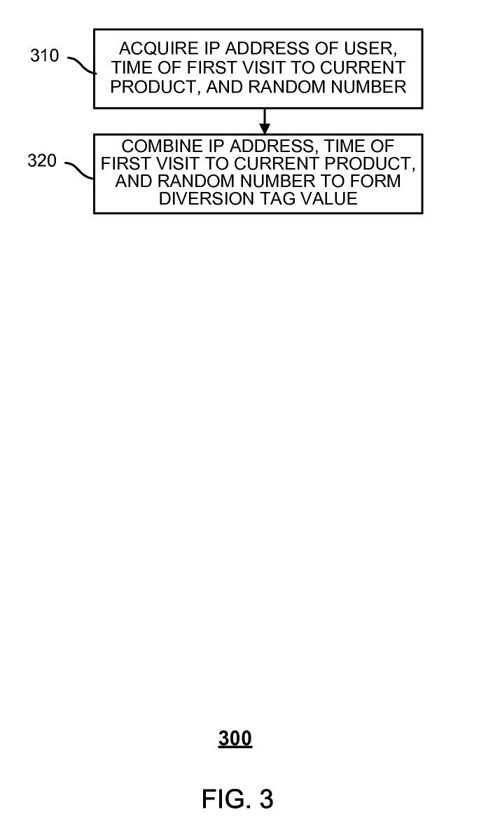

FIG. 3 is a flowchart of an embodiment of a process for generating a diversion tag value for a user. In some embodiments, the process 300 is an implementation of 230 of FIG. 2 and comprises:

In 310, the server acquires an IP address of the user, a time of a first visit to the current product, and a random number.

In some embodiments, the diversion tag value for the user is related to the IP address of the user, the time of the first visit to the current product, and the random number. In some embodiments, different diversion tag value generating techniques are used according to an actual situation or different user situation. In some embodiments, the IP address of the user and the time of the first visit to the current product is obtained directly by the server from the cookie, and the random number is randomly generated. For example, the random number is generated based on a Java language random number generation function.

In 320, the server combines the IP address, the time of the first visit to the current product, and the random number to form a diversion tag value.

In some embodiments, the obtained IP address, the time of the first visit to the current product, and the random number are combined to form the diversion tag value. For example, suppose the user's IP address is 121.0.29.199, the time of the first visit to the product is “1335163135361,” and the acquired random number is 3. For example, the time is generated based on Java language data and time generation functions. In that case, the three numerical values could be combined using “.” as a separating symbol. For example, the user's diversion tag value is: 121.0.29.199.1335163135361.3. The combining of the IP address, the time of the first visit to the current product, and the random number make the diversion tag value both unique and hashable. In other words, by making the diversion tag value hashable, the diversion tag value is randomly distributed.

Referring back to FIG. 2, in 240, the server adds the diversion tag value into the user's cookie.

In some embodiments, the generated diversion tag value is written into the cookie of the user in the event that the server responds to the user's request. In this way, the diversion tag value can be directly obtained from the user's cookie the next time the user visits the current product.

Referring back to FIG. 1, in 120, the server calculates diversion hashed values of the diversion tag values.

After obtaining the diversion tag value of the user, the server is to convert the diversion tag value into a hash code value (where if the converted hash code value is negative, an absolute value of the converted hash code value is calculated to obtain a positive hash code value) and then hashes the positive hash code value to obtain a diversion hashed value corresponding to the diversion tag value. The diversion hashed value indicates that this user is to go to either the old version or the new version of the current product. For example, suppose a pre-allocated ratio between the old version and the new version is 50%:50%. In some embodiments, the ratio is determined based on A/B testing, empirical testing of needs, etc. The pre-allocated ratio indicates that 50% of users will visit the old version, and 50% of users will visit the new version. In this case, the diversion hashed value can be a number from 0 to 99. In actual practice, calculating the diversion hashed value entails converting the cookie value of the user to a positive hash code value and then using a remainder of the positive hash code value for 100 so that the diversion tag value is hashed into a diversion hashed value of 0-99. For example, the server takes the absolute value of the hash code and calculates the remainder of the positive hash code by dividing by 100. In some embodiments, a remainder is taken on the basis of 10 so that the diversion tag value is hashed into a diversion hashed value of 0-9, etc. In this example, the server takes the absolute value of the hash code and calculates the remainder of the positive hash code by dividing by 10.

In 130, the server allocates the old version or the new version of the current product to the user according to a preset old version-new version allocation ratio for the current product and the diversion hashed value to test multiple versions of the current product.

If users undergo multiple version testing based on “diversion according to user ratio” and the preset diversion allocation ratio for the old version and the new version of the current product is 20%:80%, that means that 20% of users are diverted to an old version A, and 80% of users are diverted to a new version B. In actual application, a graphic user interface can be provided for inputting or displaying the allocation ratio of the current product between the old version and the new version.

In actual application, assuming that the pre-allocated old version-new version ratio is 20%:80%, in the event that the hashed number for user A is 18, the user A is to always fall within the 0-19 range. Therefore, in this operation, the old version A of the current product is to be allocated to the user A. Therefore, the user A is to always see the old version A when visiting the current product. In another aspect, the hashed value for another user B is 59. So the user B is to fall within the 20-99 range. Therefore, in this operation, the new version B of the current product is to be allocated to the user B, and this user B is to always see the new version B when visiting the current product.

Please note that the allocation ratio between the old version and the new version can be preset in many ways. For example, allocations are made according to the number of users, i.e., how much of a proportion of users are allocated to the old version A and how much of a proportion of users are allocated to the new version B. In the event that the allocation ratio is set according to the number of user requests, the allocation ratio would represent the following: Out of a certain number of requests directed at the current product, how many requests are to be allocated to the old version A and how many requests are to be allocated to the new version B. Other ways to determine the allocation ratio exist. For example, users could be diverted according to business logic, where official members of the current product are to visit the old version A, while temporary users are to visit the new version B. In some embodiments, the registered users are official members, and temporary visiting users are temporary members. In another example, users are diverted according to geographical location where local users (users located within the local geographical area) are to visit the old version A, while outside users (users located outside the local geographical area) are to visit the new version B. For example, the user's IP address is used to determine whether the user is a local user or an outside user. In some embodiments, local users visit the new version. In yet another example, users are to be diverted according to a blacklist and a whitelist, etc.

After users are allocated to the old version or the new version of the current product, a user performs the old version and new version testing of the current product based on user actions in visits to the old version versus visits to the new version. For example, testing of multiple versions of the current product is performed based on user conversion rates for visits to old versions and new versions, respectively. The conversion rate corresponds with the number of visits with a corresponding action divided by the total number of visits. The conversion rate is used to measure the attractiveness of the content of a website to visitors. Testing of multiple versions of the current product can also be performed by monitoring the number of mouse clicks or time spent by users at the old version and new version web pages of the current product. Testing of multiple versions on the current product can also be performed by recording user browsing time or other information at the old version and the new version of web pages of the current product.

In some embodiments, diversion hashed values are obtained by hashing the diversion tag value of each user. Convenient testing of multiple versions based on the diversion hashed values is provided.

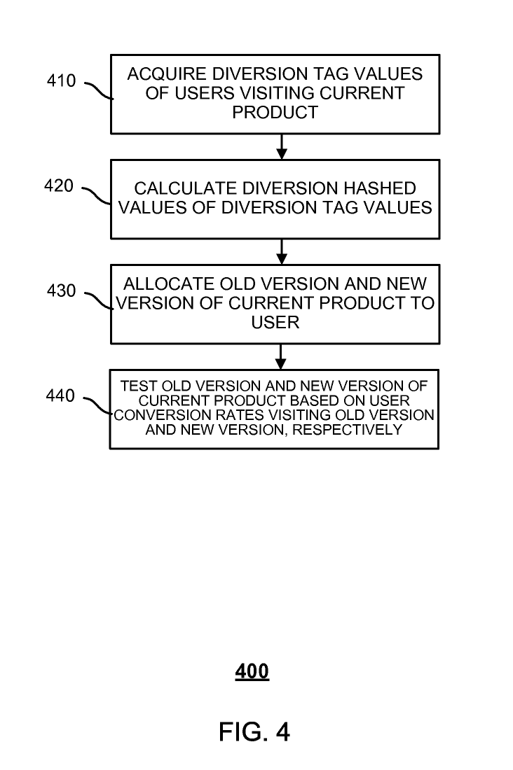

FIG. 4 is a flowchart of another embodiment of a process for testing multiple versions based on conversion rates. In some embodiments, the process 400 is implemented by a server 1320 of FIG. 13 and comprises:

In some embodiments, operations 110, 120, and 130 of FIG. 1 correspond with operations 410, 420, and 430 of FIG. 4.

In 440, after allocating an old version and a new version of a current product to a user, the server tests the old version and the new version of the current product based on user conversion rates of visiting the old version and the new version, respectively.

In light of the allocation results of operation 130, which users will visit the old version of the current product and which users will visit the new version are known. Testing the old version and the new version of the current product in light of the conversion rate for all users who visit the old version and the conversion rate of all users who visit the new version is possible. In other words, the effectiveness and commercial value of the old and new versions of the current product are analyzed by comparing the old and new version conversion rates.

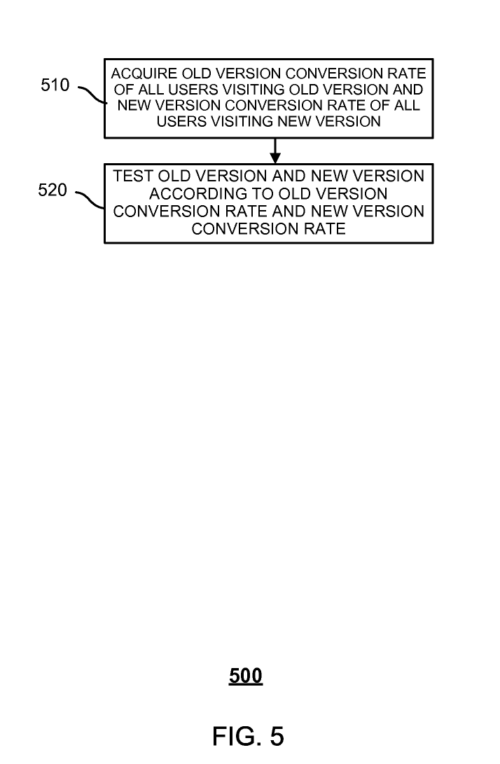

FIG. 5 is a flowchart of an embodiment of a process for testing an old version and a new version of a current product. In some embodiments, the process 500 is an implementation of 440 of FIG. 4 and comprises:

In 510, the server acquires an old version conversion rate of all users visiting an old version based on a user conversion rate for visits to the old version and a new version conversion rate of all users visiting a new version based on a user conversion rate for visits to the new version.

In some embodiments, since the server records each user visit to the old version or the new version of the current product, the old version conversion rate and the new version conversion rate are acquired through user visit information recorded by the server. A technique used to calculate the user conversion rate of a website product corresponds to a number of visits in which an appropriate action was performed divided by the total number of visits. In some embodiments, the old version conversion rate and the new version conversion rate correspond to the website conversion rate of the old version and the website conversion rate of the new version. Many kinds of website conversion rates exist. In one example, the website conversion rate of a website with a registration web page corresponds with the number of successfully registered users divided by the total number of visitors to the registration web page. In another example, the website conversion rate for detailed product information pages of an e-commerce website is how many users click on an order button after browsing a detailed product information page. As an example of acquiring an order placement conversion rate, the server counts a total number of user requests (assume, for example, 1,000 user requests) to browse a detailed information page for a certain product and how many users, out of the total number of browses corresponding to the many user requests, request (assume, for example, 35 user requests) to place an order. Thus, the order conversion rate corresponds to 35/1,000=3.5%.

In some embodiments, the website conversion rate comprises many other types of techniques. The other types of techniques are understood by one of ordinary skill and omitted for conciseness.

In 520, the server tests the old version and the new version according to the old version conversion rate and the new version conversion rate.

Based on the old version conversion rate for all old versions and the new version conversion rate for all new versions, the conversion rates of the two versions are compared and the effectiveness of the old version and the new version are tested. In some embodiments, the version conversion rate indicates effectiveness of the version in question. For example, assume the new version conversion rate is higher than the old version conversion rate. In this case, the new version's effectiveness or commercial value is higher than the old version's effectiveness or commercial value. Typically, since individual differences exist between users, in the event that the new version conversion rate is higher than the old version conversion rate by a predetermined numerical value, the effectiveness test results in a relatively credible result. Examples of numerical values include 3%, 5%, etc. Of course, different products have different characteristics and also have different empirical values. In some embodiments, different products have different empirical values, which are determined based on total users, differences, the characteristics of the product itself, etc. For example, the empirical values are determined based on certain experiments, such as executing an AB test for two versions having the same content, and the empirical conversion rate difference between the two versions corresponds to the difference between the empirical values of the two versions. In an example of how much higher the new version conversion rate is to be for a certain product over the old version conversion rate in order to regard the effectiveness test result as credible, persons of ordinary skill in the art can reference historical experiences of product conversion rate increases to form basic assessments and expectations.

It is understood that the types of website products that are tested differ (e.g., registration conversion rates can be compared for registration pages, and order placement conversion rates can be compared for detailed product information pages), as well as the types of website conversion rates that are to be compared. When one of ordinary skill in the art performs new version and old version effectiveness tests, appropriate website conversion rates for comparison can be selected according to an actual business situation or a user need.

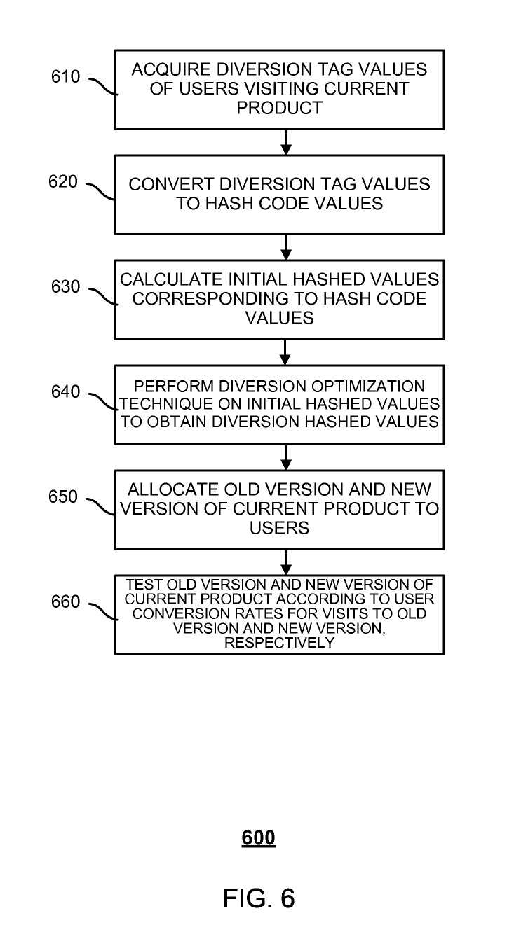

In practical applications, test results obtained during the testing of multiple versions do not require that the new version conversion rate be higher than the old version. If the increase in effectiveness of the new version is not insignificant, e.g., the increase in effectiveness is about 4% greater than the old version, the credibility of the test can be concluded to be validated, since this test result is likely to have been caused by differences in individual samples. In such a situation, user diversion tag values can be optimized to verify test results. FIG. 6 is a flowchart of yet another embodiment of a process for testing multiple versions. In some embodiments, the process 600 is implemented by a server 1320 and comprises:

In 610, the server acquires diversion tag values of users visiting a current product. In some embodiments, the diversion tag values uniquely identify the corresponding users.

In some embodiments, the diversion tag values are acquired by operation 110 of FIG. 1.

In 620, the server converts the diversion tag values to hash code values.

In some embodiment, the acquired diversion tag values are converted to positive hash code values as discussed in operation 120 of FIG. 1.

In 630, the server calculates initial hashed values corresponding to the hash code values.

In 640, the server performs a diversion optimization technique on the initial hashed values to obtain diversion hashed values.

In some embodiments, the process 100 differs from process 600 in that, in process 600, the initial hashed values undergo the diversion optimization technique to obtain the optimized diversion hashed values.

At least four approaches of the diversion optimization technique exist. A first approach includes obtaining shifted diversion hashed values after shifting the initial hashed values according to a preset shift span.

When such an optimization approach is applied, the obtained initial hashed values are to be shifted according to a preset shift span to attain an objective of modifying user ranges allocated to the old version and to the new version. For example, a preset allocation ratio for the new version and the old version is 20:80, and the preset shift span is 50. Although the server diverts 20% of users to the new version according to the preset allocation ratio, the preset shift span that is added is 50. Thus, the actual situation is as follows: in the event that the initial hashed value of user A remains set to 18 and is not shifted, the new version is to be allocated to this user. However, after the initial hashed value is shifted by the preset shift span, the initial hashed value becomes 68, and the old version is to be allocated to the user. In another example, the initial hashed value of the user B is set to 59. In the event that no shift is performed on the initial hashed value of the user B, the old version will be allocated to this user. However, in the event that the first optimization approach is employed, and the initial hashed value of the user B is shifted 50, the result will be 109. In other words, the diversion hashed value is to be set to 9. Thus, when optimization occurs, the new version is to be allocated to this user.

Of course, in actual applications, the numerical value of the shift span can be set according to the actual situation, user needs, or a new-old version allocation ratio. Typically, where credibility of the previous test result merits deliberation, adoption of the first optimization approach can ensure the random nature of the testing of multiple versions and make possible adoption of a set of relatively new users to test the new version. The first optimization approach can thus verify whether the testing of the multiple versions is affected by individual differences. In the event that the shift factor-based test results have the same effectiveness as before, credibility has been boosted. In the event that the shift factor-based test results do not have the same effectiveness as before, the previous results of the testing of the multiple versions is not accurate. Because different individuals have differences that can cause testing results to be inaccurate, the testing results are to be adjusted to be more accurate. In some embodiments, several shifts are performed, and the spans of the shifts are flexibly assigned.

In a second approach, the server inverts the initial hashed values according to a preset inversion rule to obtain inverted diversion hashed values.

The second approach uses inversion to optimize the initial hashed value. The second approach is typically suitable for situations where one new and one old version exist. For example, all of the users whose diversion tag values fall within the old version range are allocated to the new version, and all of the users whose diversion tag values fall within the new version range are allocated to the old version. Thus, switching old version and new version user ranges is possible. In the event that the test result after the inversion optimization is carried out remains that the new version is better than the old version, typically a conclusion that the optimization process was effective is possible. Inversion optimization is an example of shifting optimization. Typically, the second approach is used when only two versions, new and old, exist and quick verification of the testing of the multiple versions is to be performed. Since the inversion optimization approach affects all product users, the second approach is an appropriate choice based on certain conditions.

In a third approach, the server multiplies the initial hashed values with a preset multiplier to obtain multiplied diversion hashed values.

The third approach multiplies the initial hashed values with a preset multiplier to obtain the multiplied diversion hashed values and regards the multiplied diversion hashed values as final diversion hashed values. For example, all the initial hashed values are multiplied by the numerical value “3.” The users that are allocated to the old version or to the new version can be changed by changing the initial hashed values to final diversion hashed values. Please note that the numerical value of the preset multiplier can be adjusted according to actual conditions. The numerical value of the preset multiplier is to be a designated number. Typically, the third optimization approach is used to prevent mutual interference from diversion of a plurality of parallel tests of multiple versions of the same product.

In a fourth approach, the server hashes the initial hashed values according to a preset time parameter to obtain hashed diversion hashed values.

The fourth approach of optimizing the initial hashed values includes hashing the initial hashed values according to a preset time parameter to obtain hashed diversion hashed values. In some embodiments, the preset time parameter is a numerical value. The preset time parameter differs from the third approach in which the multiplier is, once it has been set, always the same designated number. As an aspect, in the event that the time parameter is preset as the current date, the number with which the initial hashed value is multiplied is to be the current date in tests of the multiple versions performed on different dates. The current date is to be a variable. In this example, the fourth approach uses the time parameter or current date as the multiplier. Because the time parameter changes daily, the multiplier changes from a fixed value to a varying value. The fourth optimization approach analyzes fluctuations in how website products are affected by user group actions. The time parameter is not limited to “day” as the unit of optimization. In some embodiments, the time parameter corresponds to units such as “hour” or “week” to perform optimizations. For example, if “hour” is used as the time parameter, numbers representing the hour are multiplied with the initial hashed values in different hours. In another example, in the event that “week” is used, numbers representing the week are multiplied with the initial hashed values in different weeks.

Please note that any of the above four approaches can be selected in the optimization process. In the event that after performing an optimization, the credibility of the old version and new version test results still is not high, then other optimization approaches can be performed based on shift spans, multipliers, time parameters, etc.

In some embodiments, operations 620 to 640 of FIG. 6 are an implementation of operation 120 of FIG. 1.

In 650, the server allocates the old version and the new version of the current product to the users based on a preset old version and new version allocation ratio for the current product and the diversion hashed value.

In 660, the server tests the old version and the new version of the current product according to user conversion rates for visits to the old version and new version, respectively.

In some embodiments, the server hashes the diversion tag values of all users to obtain diversion hashed values, with the result that users who originally would have been allocated to the old version are, because of the change in the hashed values, to be allocated to the new version and users who would have been allocated the new version are, because of the change in the hashed values, to be allocated to the old version. In this way, reducing the impact of differences in behavior between users on the test results and verifying the credibility and validity of testing of multiple versions are possible.

In actual applications, one user request in the process for testing multiple versions can involve different test contents. For example, the process for testing multiple versions enters one process for testing multiple versions and then enters another process for testing multiple versions, in which parallel testing approaches can be employed to reduce time. For example, suppose that two parallel processes for testing multiple versions are simultaneously performed on a website product, and one approach that is employed is “diversion according to user ratio.” Thus, in the case of one user visit, the user enters one process for testing multiple versions (assume that the old version is sellpopA and that the new version is sellpopB) and thereupon enters another process for testing multiple versions.

Thus, for the users who are to visit the website, assume that the users first undergo sellpop testing: 50% of the users are assigned to visit sellpopA, and the other 50% of the users visit sellpopB. In other words, the ratio of sellpopA:sellpopB is 50%:50%. Subsequently, the sellpopB user contingent then undergoes a second multiple version testing process for popp4p. 20% of these sellpopB users are assigned to visit popp4pA, another 20% of the sellpopB users are assigned to visit popp4pB, and the remaining 60% of the sellpopB users visit popp4pC. In other words, the ratio of popp4pA:popp4pB:popp4pC is 20%:20%:60%. In actual operation, the diversion ratio of actual sellpop testing users relates to a preset allocation ratio, while the actual user diversion ratio for popp4p testing is irregular. Actually no users visit popp4pA and popp4pB, which fails to match the 20% of users expected for each website. This shows that in actual practice, parallel processes for testing multiple versions develop mutually interfering diversion flows. To illustrate interference between two tests, because sellpop testing exists and the sellpop and popp4p tests have a dependent relationship, only sellpopB users enter into the popp4p test causing the popp4p testing to fail having the expected number of users visit.

The example below shows how an optimization process avoids mutual interference of diversion flows in parallel testing.

In analyzing the reasons for the abnormal user diversion flows in the above example, users who enter the website product in the above example first undergo sellpop testing. 50% of the users who enter the website product are diverted to visit sellpopA and the other 50% of the users who enter the website product are diverted to visit sellpopB. Next, the users diverted to sellpopB then undergo popp4p testing, and 20% of these users are diverted to visit popp4pA, 20% are diverted to visit popp4pB, and the other 60% are diverted to visit popp4 pC. Because the sellpop and popp4p testing of multiple versions are performed during the same period of time, user requests to visit the website products first undergo sellpop testing and then undergo popp4p testing.

The assumption is next made that user A has a diversion hashed value of 25 and belongs within the 0 to 50 range. Thus, the user A is to be assigned to visit sellpopA during the sellpop testing. In other words, the user A does not enter the second process of testing multiple versions (popp4p). In the event that user B has a diversion hashed value 69 and belongs within the 50 to 99 range, this user is to be assigned to visit sellpopB during sellpop testing. Subsequently, when entering the second process of testing multiple versions pop4p, the user B is to be assigned to visit pop4pC. The result is that, to be able to enter popp4p testing, users' hashed values are to be in the 50 to 99 range. In other words, the users' hashed values do not belong to the 0 to 19 or the 20 to 39 ranges. Consequently, no chance of visits to the pop4pA version or the pop4pB version exists.

Optimization is performed using the third approach when the second process of testing multiple versions of popp4p is entered in a serial fashion. Assume that the preset multiplier is 15. Thus, although the new version-old version ratio is still 20:80, all of the user diversion tag values are to be multiplied by the preset multiplier 15. In such a situation, the diversion hashed values of the user diversion tag values are to be in the 50 to 99 range, and suppose that an initial diversion tag value is 169 (the diversion hashed value is 69, which is in the 50 to 99 range). The diversion tag value multiplied by the preset multiplier is 169*15=2,535. The diversion hashed value is then calculated by calculating the remainder when divided by 100. The result of the calculation is 35. Thus, when the corresponding user enters popp4p testing, the diversion hashed value of the user is to be in the 20 to 39 range and the user is assigned to visit popp4pB.

Assume that the user's initial diversion tag values are other numerical values, e.g., 169, 182, 191 and 199. The optimized diversion hashed values with their correspondences are shown in Table 1:

TABLE 1

| | | Hashed value after |
|---|---|---|
| | Non-optimized | optimizing with preset |
| Initial diversion tag | diversion hashed | multiplier (popp4p |
| value (sellpop test) | value (popp4p test) | test) |
| 169 | 69 | 35 |
| 182 | 82 | 30 |
| 191 | 91 | 65 |
| 199 | 99 | 85 |

As shown in Table 1, the original, non-optimized diversion hashed values are in the 50 to 99 range. After optimization, the diversion hashed values are in the 0 to 99 range. Thus, both the pop4pA and the pop4pB versions can be visited by users. In other words, mutual interference of diversion flows that occurs in parallel multi-version testing is avoided.

Optimization of the initial hashes of all user diversion tag values to obtain diversion hashed values allows users who originally would have been allocated to the old version to be allocated to the new version because of a change in the hashed values and users who would have been allocated to the new version to be allocated to the old version because of a change in the hashed values. Thus, in comparison to conventional processes, the processes for testing of multiple versions have increased validity and accuracy. The processes for testing of multiple versions provide an effective verification method and reduce mutual interference of diversion flows that arises when multiple processes for testing multiple versions are conducted in parallel.

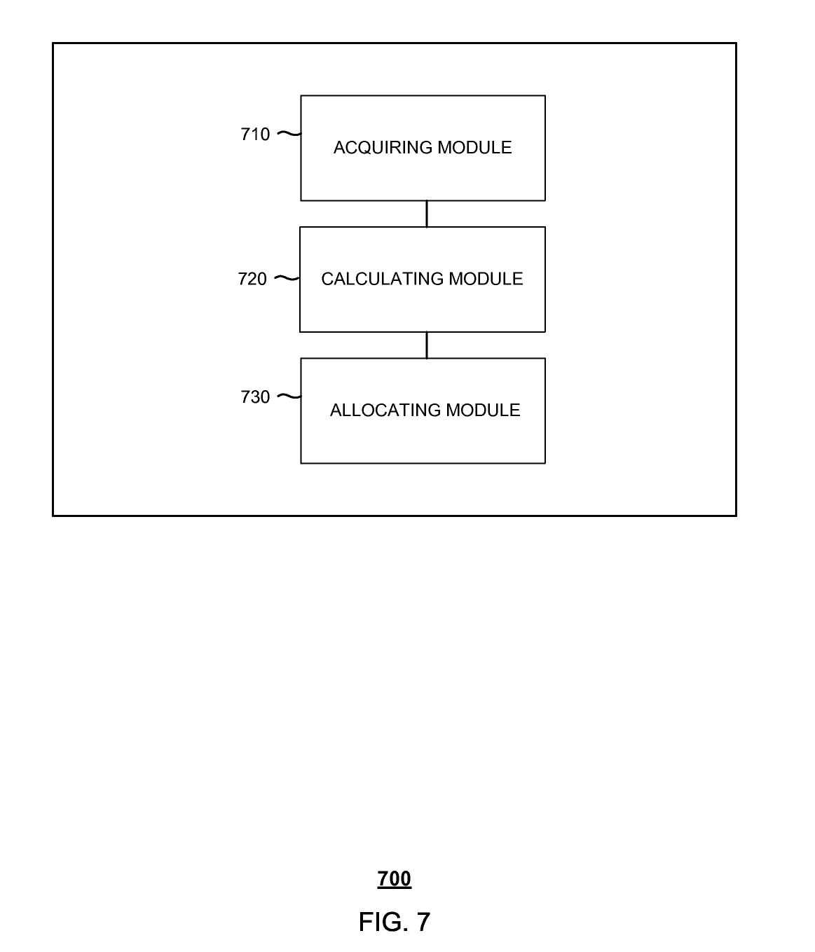

FIG. 7 is a structural diagram of an embodiment of a device for testing multiple versions. In some embodiments, the device 700 implements the process 100 and comprises an acquiring module 710, a calculating module 720, and an allocating module 730.

The acquiring module 710 acquires diversion tag values of users visiting a current product. In some embodiments, the diversion tag values uniquely identify the corresponding users.

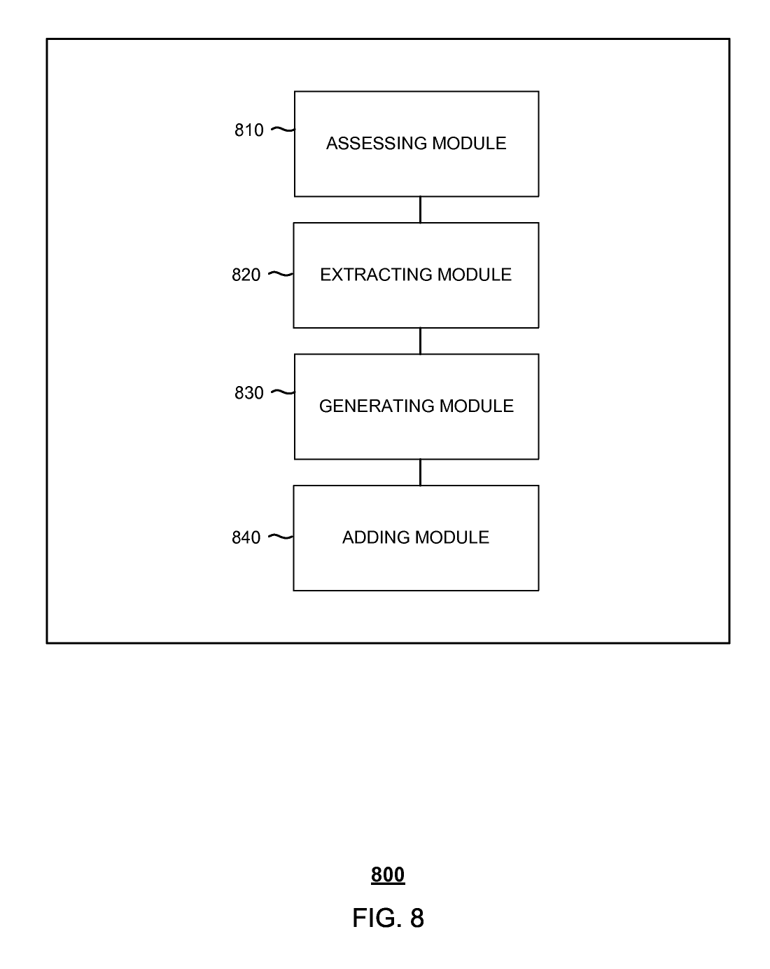

FIG. 8 is a structural diagram of an embodiment of an acquiring module. In some embodiments, the module 800 is an implementation of the acquiring module 710 of FIG. 7 and comprises an assessing module 810, an extracting module 820, a generating module 830, and an adding module 840.

The assessing module 810 determines whether user access data cookies have diversion tag values.

The extracting module 820 directly extracts the diversion tag values from the user access data cookies in the event that the assessing module 810 determines that the user access data cookies have the diversion tag values.

The generating module 830 generates diversion tag values for the users according to a preset diversion tag value generating technique in the event that the assessing module 810 determines that the user access data cookies do not have the diversion tag values.

The adding module 840 adds the diversion tag values to the user access data cookies.

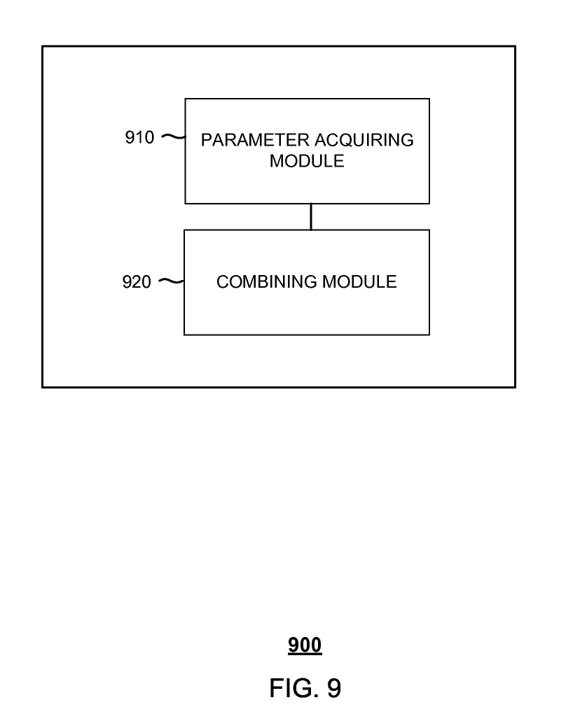

FIG. 9 is a structural diagram of an embodiment of a generating module. In some embodiments, the module 900 is an implementation of the generating module 830 of FIG. 8 and comprises a parameter acquiring module 910 and a combining module 920.

The parameter acquiring module 910 acquires an IP address of a user, the time of a first visit to a current product, and a random number.

The combining module 920 combines the IP address of the user, the time of the first visit to the current product, and the random number to form a diversion tag value.

Referring back to FIG. 7, the calculating module 720 calculates diversion hashed values of the diversion tag values.

The allocating module 730 allocates the old version or the new version of the current product to the users according to a preset old version and new version allocation ratio for the current product and the diversion hashed value to test multiple versions of the current product.

In some embodiments, the calculating module 720 further obtains diversion hashed values by hashing the diversion tag values of all users. The device 700 can conveniently be implemented based on cookies and hashed numbers, and in this way, a convenient process for testing multiple versions based on the diversion hashed values is provided.

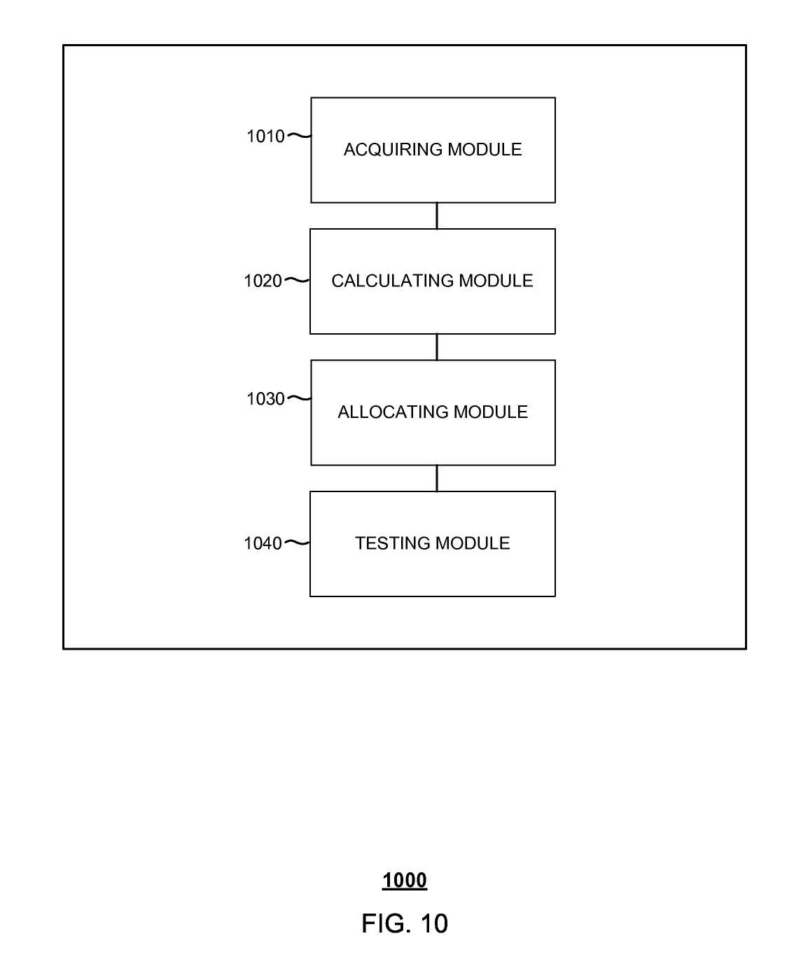

FIG. 10 is a structural diagram of an embodiment of a device for testing multiple versions including a testing module. In some embodiments, the device 1000 implements the process 400 of FIG. 4 and comprises an acquiring module 1010, a calculating module 1020, an allocating module 1030, and a testing module 1040.

In some embodiments, the acquiring module 1010, the calculating module 1020, and the allocating module 1030 correspond with the acquiring module 710, the calculating module 720, and the allocating module 730 of FIG. 7, respectively.

The testing module 1040 tests an old version and a new version of the current product according to a user conversion rate for visits to the old version and the new version, respectively.

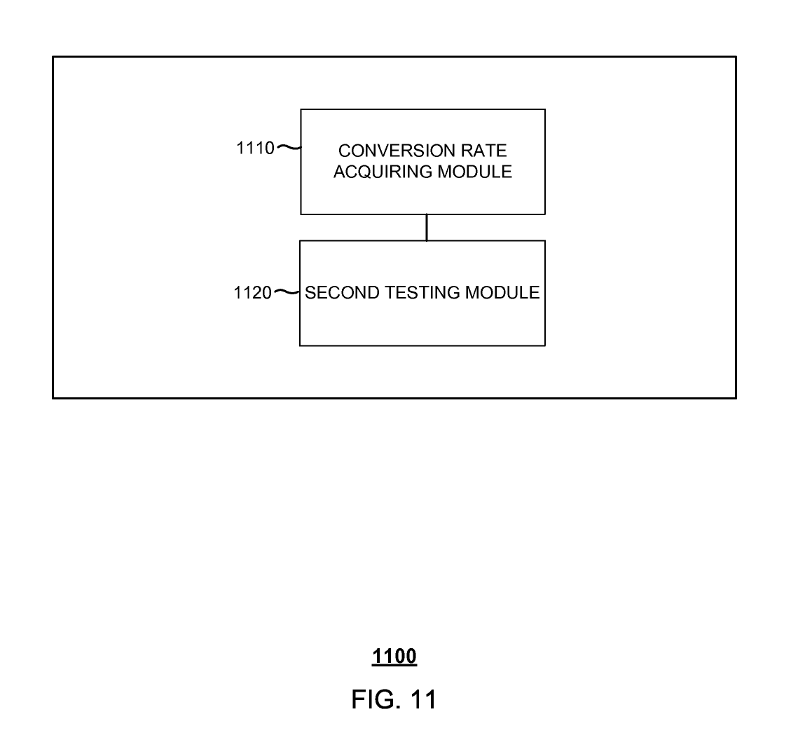

FIG. 11 is a structural diagram of an embodiment of a testing module. In some embodiments, the testing module 1100 is an implementation of the testing module 1040 of FIG. 10 and comprises a conversion rate acquiring module 1110 and a second testing module 1120.

The conversion rate acquiring module 1110 acquires old version conversion rates of all users visiting the old version and new version conversion rates of all users visiting the new version.

The second testing module 1120 performs tests on the old version and new version according to the old version conversion rate and new version conversion rate, respectively.

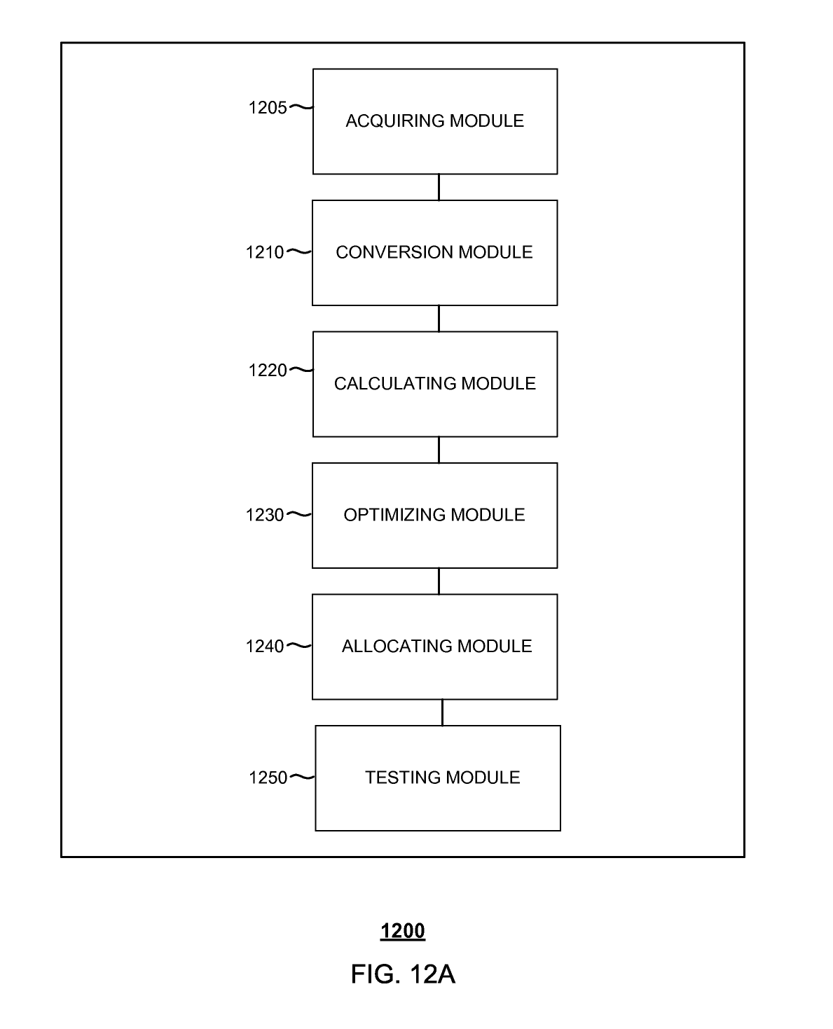

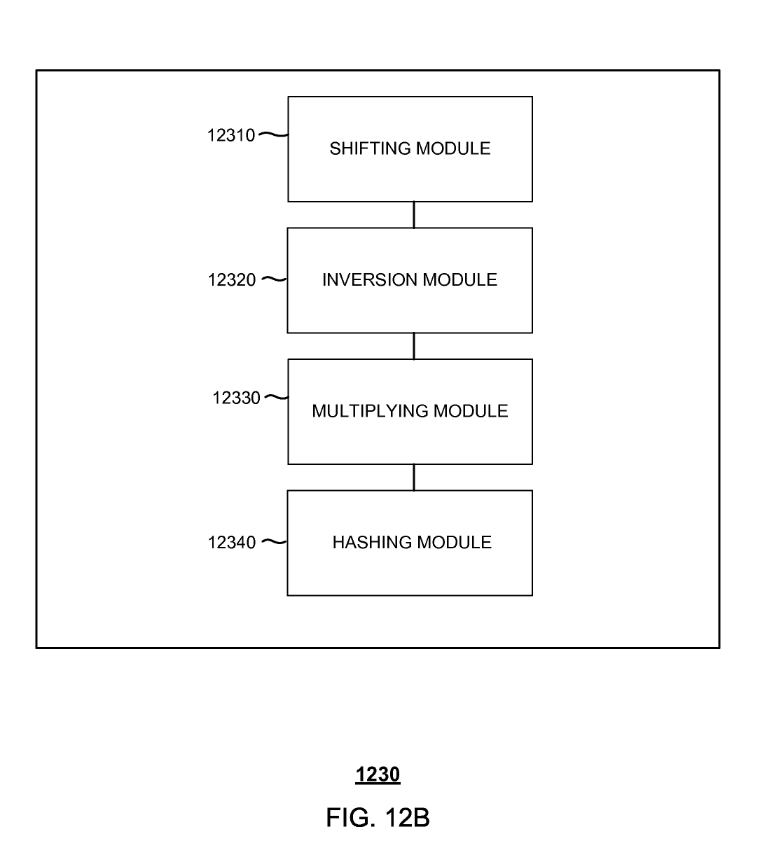

FIG. 12A is a structural diagram of yet another embodiment of a device for testing multiple versions. In some embodiments, the device 1200 implements the process 600 and comprises an acquiring module 1205, a conversion module 1210, a calculating module 1220, an optimizing module 1230, an allocating module 1240, and a testing module 1250.

In some embodiments, the acquiring module 1205 corresponds with the acquiring module 710 of FIG. 7 and acquires diversion tag values of users visiting a current product. In some embodiments, the diversion tag values uniquely identify the corresponding users.

The conversion module 1210 converts the diversion tag values to hash code values.

The calculating module 1220 calculates initial hashed values corresponding to the hash code values.

The optimizing module 1230 performs a diversion optimization technique on the initial hashed values to obtain diversion hashed values.

FIG. 12B is a structural diagram of an embodiment of an optimizing module. In some embodiments, the optimizing module 1230 comprises one or more of the following: a shifting module 12310, an inversion module 12320, a multiplying module 12330, or a hashing module 12340.

The shifting module 12310 shifts the initial hashed values according to a preset shifting span to obtain shift diversion hashed values.

The inversion module 12320 inverts the initial hashed values according to a preset inversion rule to obtain inverted diversion hashed values.

The multiplying module 12330 multiplies the initial hashed values with a preset multiplier to obtain multiplied diversion hashed values.

The hashing module 12340 hashes the initial hashed values according to a preset time parameter to obtain hashed diversion hashed values.

In some embodiments, the allocating module 1240 corresponds with the allocating module 730 of FIG. 7 and allocates the old version and the new version of the current product to the users according to a preset old version and new version allocation ratio for the current product and the diversion hashed value.

In some embodiments, the testing module 1250 corresponds to the testing module 1040 of FIG. 10 and tests the old version and the new version of the current product according to the user conversion rate for visits to the old version and the new version, respectively.

In some embodiments, the diversion hashed values are obtained by optimizing the initial hashed values of the diversion tag values of all users with the result that users who originally would have been allocated to the old version are, because of a change in the hashed values, allocated to the new version and users who would have been allocated to the new version are, because of a change in the hashed values, allocated to the old version. In this way, an impact of differences in behavior between users on the test results is reduced and verification of the credibility and validity of testing multiple versions is possible.

FIG. 13 is a diagram of an embodiment of a system for testing multiple versions. In some embodiments, the system 1300 includes a client 1310 connected to a server 1320 via a network 1330.

Users, using the client 1310, send corresponding diversion tag values to the server 1320 visiting a current product across the network 1330. Testing of multiple versions of a webpage is performed based on the received diversion tag values.

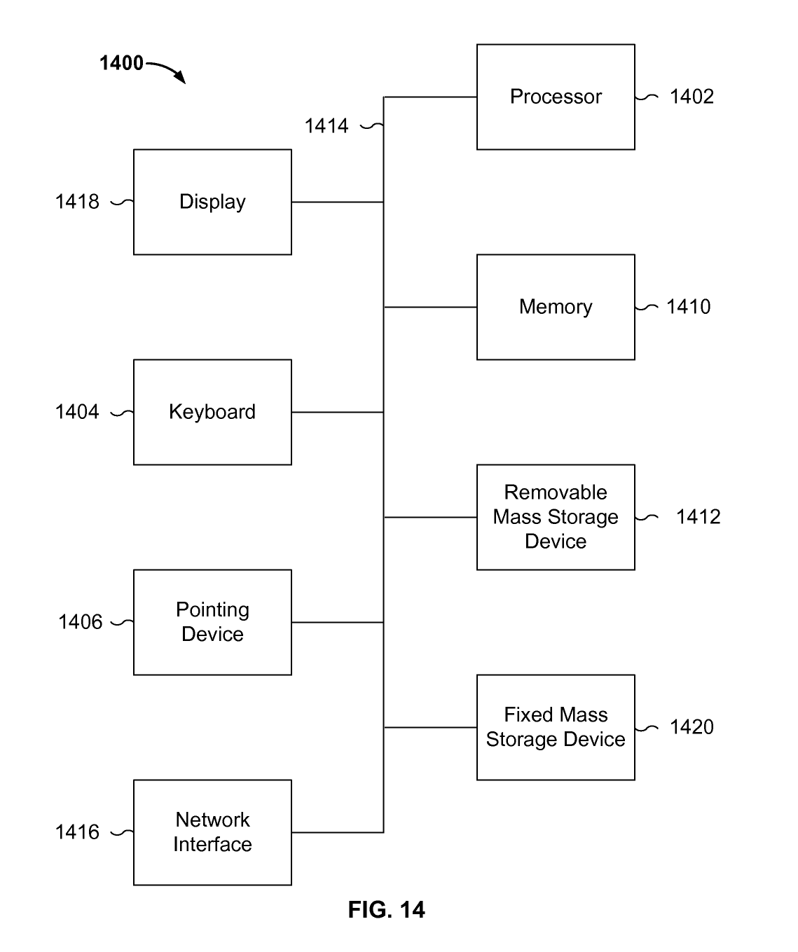

FIG. 14 is a functional diagram of an embodiment of a computer system for testing multiple versions. As will be apparent, other computer system architectures and configurations can be used to test multiple versions. Computer system 1400, which includes various subsystems as described below, includes at least one microprocessor subsystem (also referred to as a processor or a central processing unit (CPU)) 1402. For example, processor 1402 can be implemented by a single-chip processor or by multiple processors. In some embodiments, processor 1402 is a general purpose digital processor that controls the operation of the computer system 1400. Using instructions retrieved from memory 1410, the processor 1402 controls the reception and manipulation of input data, and the output and display of data on output devices (e.g., display 1418).

Processor 1402 is coupled bi-directionally with memory 1410, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1402. Also as is well known in the art, primary storage typically includes basic operating instructions, program code, data and objects used by the processor 1402 to perform its functions (e.g., programmed instructions). For example, memory 1410 can include any suitable computer-readable storage media, described below, depending on whether, for example, data access needs to be bi-directional or uni-directional. For example, processor 1402 can also directly and very rapidly retrieve and store frequently needed data in a cache memory (not shown).

A removable mass storage device 1412 provides additional data storage capacity for the computer system 1400, and is coupled either bi-directionally (read/write) or uni-directionally (read only) to processor 1402. For example, storage 1412 can also include computer-readable media such as magnetic tape, flash memory, PC-CARDS, portable mass storage devices, holographic storage devices, and other storage devices. A fixed mass storage 1420 can also, for example, provide additional data storage capacity. The most common example of mass storage 1420 is a hard disk drive. Mass storage 1412, 1420 generally store additional programming instructions, data, and the like that typically are not in active use by the processor 1402. It will be appreciated that the information retained within mass storage 1412 and 1420 can be incorporated, if needed, in standard fashion as part of memory 1410 (e.g., RAM) as virtual memory.

In addition to providing processor 1402 access to storage subsystems, bus 1414 can also be used to provide access to other subsystems and devices. As shown, these can include a display monitor 1418, a network interface 1416, a keyboard 1404, and a pointing device 1406, as well as an auxiliary input/output device interface, a sound card, speakers, and other subsystems as needed. For example, the pointing device 1406 can be a mouse, stylus, track ball, or tablet, and is useful for interacting with a graphical user interface.

The network interface 1416 allows processor 1402 to be coupled to another computer, computer network, or telecommunications network using a network connection as shown. For example, through the network interface 1416, the processor 1402 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1402 can be used to connect the computer system 1400 to an external network and transfer data according to standard protocols. For example, various process embodiments disclosed herein can be executed on processor 1402, or can be performed across a network such as the Internet, intranet networks, or local area networks, in conjunction with a remote processor that shares a portion of the processing. Additional mass storage devices (not shown) can also be connected to processor 1402 through network interface 1416.

An auxiliary I/O device interface (not shown) can be used in conjunction with computer system 1400. The auxiliary I/O device interface can include general and customized interfaces that allow the processor 1402 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 14 is but an example of a computer system suitable for use with the various embodiments disclosed herein. Other computer systems suitable for such use can include additional or fewer subsystems. In addition, bus 1414 is illustrative of any interconnection scheme serving to link the subsystems. Other computer architectures having different configurations of subsystems can also be utilized.

The units described above can be implemented as software components executing on one or more general purpose processors, as hardware such as programmable logic devices, and/or Application Specific Integrated Circuits designed to perform certain functions or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices. The functions of the units may be merged into one another or further split into multiple sub-units.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for testing multiple versions, comprising:
acquiring diversion tag values of users visiting a current product, the diversion tag values uniquely identifying the corresponding users;
calculating diversion hashed values of the diversion tag values; and
allocating an old version or a new version of the current product to the users according to a preset old version and new version allocation ratio for the current product and the diversion hashed values to test multiple versions of the current product.

2. The method as described in claim 1, wherein the acquiring of the diversion tag values of the users visiting the current product comprises:
determining whether a cookie in a web request of a user has a diversion tag value;
in the event that the cookie in the web request of the user has the diversion tag value, extracting the diversion tag value from the user's cookie; and
in the event that the cookie in the web request of the user does not have the diversion tag value:
generating a diversion tag value for the user based on a preset strategy for generating diversion tag values; and
adding the diversion tag value to the user's cookie.

3. The method as described in claim 2, wherein the generating of the diversion tag value for the user comprises:
acquiring an Internet Protocol (IP) address of the user, a time of a first visit to the current product, and a random number; and
combining the IP address of the user, the time of the first visit to the current product, and the random number to form the diversion tag value.

4. The method as described in claim 1, wherein the calculating of the diversion hashed values of the diversion tag values comprises:
converting the diversion tag values to hash code values;
calculating initial hashed values corresponding to the hash code values; and
performing a diversion optimization technique on the initial hashed values to obtain the diversion hashed values.

5. The method as described in claim 4, wherein the performing of the diversion optimization technique on the initial hashed values to obtain the diversion hashed values comprises:
performing one of the following operations:
shifting the initial hashed values according to a preset shifting span to obtain the diversion hashed values;
inverting the initial hashed values according to a preset inversion rule to obtain the diversion hashed values;
multiplying the initial hashed values with a preset multiplier to obtain the diversion hashed values; or
hashing the initial hashed values according to a preset time parameter to obtain the diversion hashed values.

6. The method as described in claim 1, wherein the testing of the multiple versions of the current product comprises:
testing the old version and the new version of the current product according to user conversion rates of visiting the old version and the new version, respectively.

7. The method as described in claim 6, wherein the testing of the old version and the new version of the current product according to the user conversion rates of visiting the old version and the new version, respectively, comprises:
acquiring an old version conversion rate of users visiting the old version and a new version conversion rate of users visiting the new version; and
testing the old version and the new version according to the old version conversion rate and the new version conversion rate.

8. A device for testing multiple versions, comprising:
at least one processor configured to:
acquire diversion tag values of users visiting a current product, the diversion tag values uniquely identifying the corresponding users;
calculate diversion hashed values of the diversion tag values; and
allocate an old version or a new version of the current product to the users according to a preset old version and new version allocation ratio for the current product and the diversion hashed values to test multiple versions of the current product; and
a memory coupled to the at least one processor and configured to provide the at least one processor with instructions.

9. The device as described in claim 8, wherein the acquiring of the diversion tag values of the users visiting the current product comprises to:
determine whether a cookie in a web request of a user has a diversion tag value;
in the event that the cookie in the web request of the user has the diversion tag value, extract the diversion tag value from the user's cookie; and
in the event that the cookie in the web request of the user does not have the diversion tag value:
generate a diversion tag value for the user based on a preset strategy for generating diversion tag values; and
add the diversion tag value to the user's cookie.

10. The device as described in claim 9, wherein the generating of the diversion tag value for the user comprises to:
acquire an Internet Protocol (IP) address of the user, a time of a first visit to the current product, and a random number; and
combine the IP address of the user, the time of the first visit to the current product, and the random number to form the diversion tag value.

11. The device as described in claim 8, wherein the calculating of the diversion hashed values of the diversion tag values comprises to:
convert the diversion tag values to hash code values;
calculate initial hashed values corresponding to the hash code values; and
perform a diversion optimization technique on the initial hashed values to obtain the diversion hashed values.

12. The device as described in claim 11, wherein the performing of the diversion optimization technique on the initial hashed values to obtain the diversion hashed values comprises to:
perform one of the following operations:
shift the initial hashed values according to a preset shifting span to obtain the diversion hashed values;
invert the initial hashed values according to a preset inversion rule to obtain the diversion hashed values;
multiply the initial hashed values with a preset multiplier to obtain the diversion hashed values; or
hash the initial hashed values according to a preset time parameter to obtain the diversion hashed values.

13. The device as described in claim 8, wherein the testing of the multiple versions of the current product comprises to:
test the old version and the new version of the current product according to user conversion rates of visiting the old version and the new version, respectively.

14. The device as described in claim 13, wherein the testing of the old version and the new version of the current product according to the user conversion rates of visiting the old version and the new version, respectively, comprises to:
acquire an old version conversion rate of users visiting the old version and a new version conversion rate of users visiting the new version; and
test the old version and the new version according to the old version conversion rate and the new version conversion rate.

15. A computer program product for testing multiple versions, the computer program product being embodied in a tangible non-transitory computer readable storage medium and comprising computer instructions for:
acquiring diversion tag values of users visiting a current product, the diversion tag values uniquely identifying the corresponding users;
calculating diversion hashed values of the diversion tag values; and
allocating an old version or a new version of the current product to the users according to a preset old version and new version allocation ratio for the current product and the diversion hashed values to test multiple versions of the current product.
